(19) United States
(12) Patent Application Publication
(10) Pub. No.: US 2020/0021551 A1
(43) Pub. Date: Jan. 16, 2020

(54) Systems and Methods for Controlling Messages Based Upon User Location

(71) Applicant: BI Incorporated, Boulder, CO (US)

(72) Inventors: James J. Buck, JR., Longmont, CO (US); Joseph P. Newell, Louisville, CO (US)

(21) Appl. No.: 16/032,065

(22) Filed: Jul. 10, 2018

(51) Int. Cl. H04L 12/58; H04W 4/12; H04W 4/80

(52) U.S. Cl. CPC H04L 51/20; H04W 4/029; H04W 4/80; H04W 4/12

(57) ABSTRACT

Various embodiments of the present invention provide systems and method for message gating.

### BACKGROUND OF THE INVENTION

The present invention is related to monitoring individuals, and in particular to systems and methods for assuring particular individuals are receiving and sending messages.

Large numbers of individuals are currently monitored as part of parole requirements or other requirements. Such monitoring allows a monitoring agency to determine whether the individual is engaging in acceptable patterns of behavior, and where an unacceptable behavior is identified to stop such behavior going forward. In many monitoring systems, a home unit is used that receives and sends messages, however, there is often no way to determine who is receiving and sending the messages.

Thus, for at least the aforementioned reasons, there exists a need in the art for more advanced approaches, devices and systems for monitoring.

### BRIEF SUMMARY OF THE INVENTION

The present invention is related to monitoring individuals, and in particular to systems and methods for assuring particular individuals are receiving and sending messages.

This summary provides only a general outline of some embodiments according to the present invention. Many other objects, features, advantages and other embodiments of the present invention will become more fully apparent from the following detailed description, the appended claims and the accompanying drawings and figures.

### BRIEF DESCRIPTION OF THE DRAWINGS

A further understanding of the various embodiments of the present invention may be realized by reference to the figures which are described in remaining portions of the specification. In the figures, similar reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram of a system capable of gating messages to a human subject based upon location of the human subject in accordance with some embodiments;

FIG. 2 is a flow diagram depicting a method for gating messages to/from a human subject based upon the location of the human subject in accordance with various embodiments;

FIG. 3 is a flow diagram depicting another method for gating messages to/from a human subject based upon the location of the human subject in accordance with various embodiments;

FIG. 4a-4b are block diagrams illustrating a monitoring system and a target monitor device capable of interacting with a messaging system based at least in part on the location of the target monitor device in accordance with one or more embodiments; and

FIGS. 5a-5c are block diagrams illustrating examples of a home based communication system having location based message gating in accordance with various embodiments.

### DETAILED DESCRIPTION OF THE INVENTION

The present invention is related to monitoring individuals, and in particular to systems and methods for assuring particular individuals are receiving and sending messages.

Various embodiments provide monitoring systems that include: an identification device and a communication system. The identification device is associated with a human subject and includes a first near range communication circuit operable to wirelessly transmit an identification. The communication system is located at a predefined location. This location may be, but is not limited to, the home of the human subject or the work place of the human subject. The communication system includes: a second near range communication circuit operable to receive information from the identification device when presented within a defined distance of the communication system; a memory operable to store at least one message; and a messaging interface operable to provide the message based at least in part on communication with the identification device presented within the defined distance of the communication system. In some cases, the defined distance is less than one hundred feet. In more particular cases, the defined distance is less than twenty feet.

In some instances of the aforementioned embodiments, the identification device is a tightly associated identification device, and wherein the tightly associated identification device further includes: a strap operable to physically attach the identification device to the human subject; and a tamper circuit operable to sense when the identification device has been removed from the human subject. In various instances of the aforementioned embodiments, the first near range communication circuit is a radio frequency identification transponder circuit, and the second near range communication circuit is a radio frequency reader circuit. In other instances of the aforementioned embodiments, the first near range communication circuit is a first infrared communication circuit, and the second near range communication circuit is a second infrared communication circuit.

In one or more instances of the aforementioned embodiments, the message is an audio message, and the messaging interface is an audio speaker. In other instances of the aforementioned embodiments, the message is a text message, and the messaging interface is a visual display. In yet other instances of the aforementioned embodiments, the messaging interface is a combination of an audio interface and a visual interface. In some instances of the aforementioned embodiments, the identification device further includes a GPS location determination circuit operable to determine a physical location of the identification device. In various instances of the aforementioned embodiments, the monitoring system further includes a central monitoring system operable to receive the physical location from the identification device via the hoe communication system. In one or more instances of the aforementioned embodiments, the monitoring system further includes a messaging device operable to send the message to the home communication system.

Other embodiments provide home base communication systems that include: a near range communication system operable to determine the presence of an individual within a communication range of the home base communication system, and to provide an indication of individual presence; a memory operable to store at least one message; and a messaging interface operable to provide the message based at least in part on the indication of individual presence. In some cases, the communication range is less than one hundred feet. In other cases, the communication range is less than twenty feet.

In some instances of the aforementioned embodiments, the near range communication system includes an infrared receiver operable to receive an identification associated with a defined individual. In such instances, the indication of individual presence is provided based upon reception of the identification associated with the defined individual, and the communication range is within line of sight of the home based communication system. In other instances of the aforementioned embodiments, the near range communication system is a movement based presence determination system. In yet other instances of the aforementioned embodiments, the near range communication system is a radio frequency identification (RFID) reader. In such instances, the radio frequency identification (RFID) reader is operable to transmit information to a mobile transponder associated with a defined individual, and to receive an identification from the mobile transponder associated with the defined individual. In such instances, the indication of individual presence is provided based upon reception of the identification from the mobile transponder associated with the defined individual.

In various instances of the aforementioned embodiments, the message includes an audio message, and the messaging interface includes an audio speaker, and wherein the communication range is an audible range. In some instances of the aforementioned embodiments, the message includes a text message, and the messaging interface includes a visual display. In some instances of the aforementioned embodiments, the home base communication system further includes: a message send interface operable to provide a message send indication; and a message receive interface operable to receive and send a message only when both the message send indication and the indication of individual presence indicate are both asserted.

Yet other embodiments provide methods for assuring messages are received by a specified individual. Such methods include: receiving an audible message for an individual associated with a mobile device at a home base communication system; storing the audible message to a memory included in the home base communication system; receiving an individual identification from a mobile device at a home base communication system, where reception of the individual identification indicates that an individual associated with the mobile device is within audible range of the home base communication system; accessing the audible message from the memory included in the home base communication system; and providing the audible message via an audio speaker in the home base communication system when the individual associated with the mobile device is within audible range of the home base communication system.

As used herein the phrase “near range” is used in its broadest sense to mean any range that is suitable for a provided communication to be received by an individual. In some cases where the communication is an audio communication, the range is less than one hundred feet. In some cases, near range is even less to assure proximity to messages being displayed and/or played. As used herein, the phrase “long range” is used in its broadest sense to mean any range that is greater than five hundred feet.

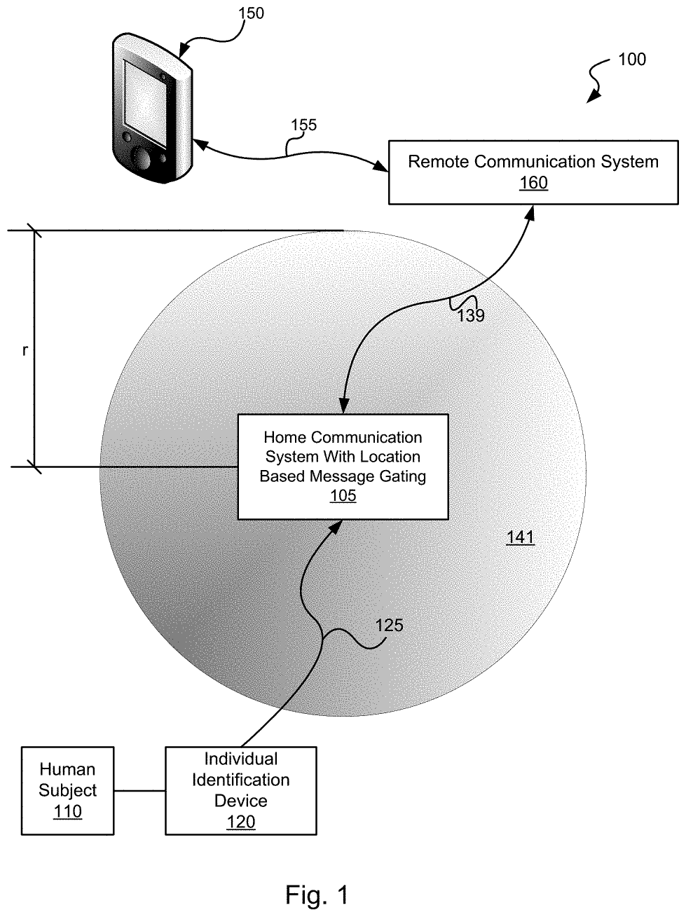

Turning to FIG. 1, a gated messaging system 100 is shown that includes a home communication system 105 including location based message gating. Home communication system 105 facilitates near range communication at a maximum distance r between an individual identification device 120 and home communication system 105. A shadow area 141 shows an expected region around home communication device 105 where near range communication with individual identification device 105 is possible. Such near range communication is done via a communication path 125. In some cases, such near range communication may be, for example, line of sight communication where communication path 125 represents an infrared communication link between individual identification device 120 and home communication system 105. In other cases, such near range communication may be, for example, radio frequency identification (RFID) where communication path 125 represents both a radio frequency power field emitted from home communication system 105 and a radio frequency message from the individual identification device 120 to the home communication system 105. Based upon the disclosure provided herein, one of ordinary skill in the art will recognize a variety of near range communication methods that may be employed in relation to different embodiments.

Individual identification device 120 is sometimes physically attached to a human subject 110 using, for example, a tamper evident strap (not shown). Thus, when individual identification device 120 is within a selected range (i.e., range r) of home communication system 105 it is highly likely that human subject is also within the selected range of home communication system 105. The only time human subject 110 would not be within the selected range is if someone had tampered with the aforementioned strap and physically removed individual identification device 120 from human subject 110. As used herein, the phrases “tightly associated identification device” or “tightly associated individual identification device” are used in their broadest sense to mean any device identifiable as being associated with an individual and that is physically attached to the individual.

In other cases, individual identification device 120 is not as securely associated with human subject 110. For example, individual identification device 120 may be an RFID card that is usually kept on the person of human subject 110. Such may include placing individual identification device 110 within the wallet, purse or pocket of human subject 110. In this scenario, when individual identification device 120 is within a selected range (i.e., range r) of home communication system 105 it is likely that human subject is also within the selected range of home communication system 105. As individual identification device 120 is not actually physically attached to human subject 110, there is some possibility that it may have been brought within range of home communication system 105. As used herein, the phrases “loosely associated identification device” or “loosely associated individual identification device” are used in their broadest sense to mean any device identifiable as being associate with an individual and that is not attached to an individual, but that is carried on the person of the individual. Another example of a loosely associated individual identification device is a cell phone that would be expected to be kept on or near the person of human subject 110. It is noted that other individual identification devices, either loosely associated or tightly associated, may be used in relation to different embodiments. Further, in some embodiments, message gating operation may be performed without an identification device associated with a particular individual where the home communication system is designed to detect the presence of an individual by, for example, detecting motion within a relatively short range of the home communication system. In such systems, messages may be gated until motion near the home communication system indicates the likely presence of an individual within range of receiving the message.

Remote communication system 160 may be any system or device that is capable of: receiving a message from a messaging device 150 via a communication link 155, and directing that message to home communication system 105; and receiving a message from home communication system 105 via a communication link 139, and forwarding that message to messaging device 150 via communication link 155. In some cases, both communication link 155 and communication link 139 are wireless communication links. In other cases, both communication link 155 and communication link 139 are wired communication links. In yet other cases, communication link 155 and communication link 139 are a combination of wired and wireless communication links.

In some cases, messaging device 150 is a cellular telephone or other wireless communication device, and in such cases remote communication system 160 may be a cellular telephone network. In other cases, messaging device 150 is a computer, and in such cases may be an Internet Service Provider (ISP). Based upon the disclosure provided herein, one of ordinary skill in the art will recognize a variety of messaging devices that may be used in relation to different embodiments. Further, based upon the disclosure provided herein, one of ordinary skill in the art will recognize various communication links and/or remote communication systems that may be used in relation to different embodiments.

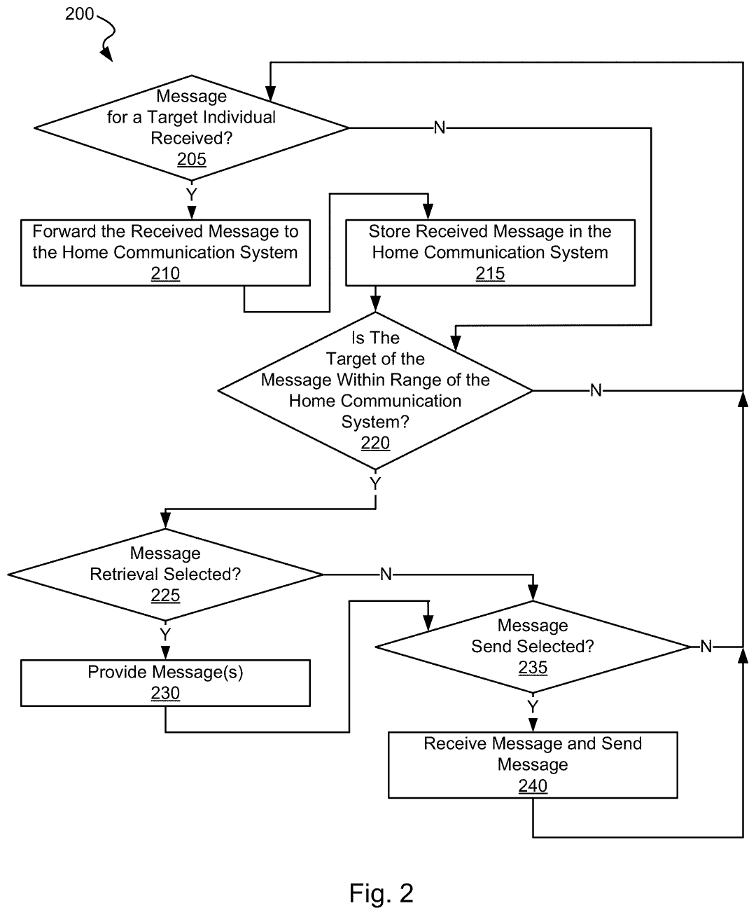

Turning to FIG. 2, a flow diagram 200 shows a method for gating messages to/from a human subject based upon the location of the human subject in accordance with various embodiments. Following flow diagram 200, it is determined if a message is received for a target individual (block 205). Such a target individual is a human subject recognized by the home communication system, and the message is received from a messaging device. The person operating the messaging device may be, but is not limited to, a parole officer, a boss, or another with an interest in whether a human subject received a message. Based upon the disclosure provided herein, one of ordinary skill in the art will recognize a variety of messaging devices and/or persons or computer programs directing messages to the human subject.

Where a message is received (block 205), the message is forwarded to the home communication system (block 210). Such forwarding of the message may be done using one or more of a wireless and/or a wired communication path between the home communication system and a remote communication system that received the message. The message is then stored by the home communication system (block 215).

Where either no message has been received for forwarding to the home messaging system (block 205) or the forwarding has already been accomplished (block 215). It is determined whether the target of the message(s) is within a defined distance (e.g., a near range) of the home communication system (block 220). Determining whether the target of the message(s) is within the defined distance includes determining whether an individual identification device associated with a human subject (i.e., the target of the message(s)) has come within a defined distance of the home communication system. As mentioned above, the individual identification device may be loosely associated with the target of the message(s), or may be a tightly associated individual identification device.

As one example, the individual identification device may be capable of communication with home communication system using an RFID approach where the individual identification device is powered when it enters a radio frequency power field emitted from the home communication system, and upon being powered by a radio frequency power field transmits a radio frequency signal including a message with an identification associated with the target of the message(s). In such cases, the defined distance of the home communication system may be a distance at which RFID communication can be carried out between the individual identification device and the home communication system. As another example, the individual identification device may be capable line of sight communication with the home communication system using, for example, infrared signaling. In such cases, the defined distance of the home communication system may be a distance at which infrared communication can be carried out between the individual identification device and the home communication system. In some cases, the home communication system is deployed in a room of a building effectively limiting the distance at which communication may be carried out. Such near range communication methods assure that the target of the message(s) is within range of the individual identification device, and thus provides reasonable assurance that the target will received the message(s) as the target is within a defined distance (e.g., r) from the home messaging device. Based upon the disclosure provided herein, one of ordinary skill in the art will recognize a variety of near range communication methods that may be employed in relation to different embodiments.

Where it is determined that the target of the message(s) is within the defined distance of the home communication system (block 220), it is determined whether there are messages to be played to the target (block 225). This includes determining whether there are any previously un-played or un-accessed messages in the memory of the home communication system. Where there are messages to be played (block 225), those messages are provided to the target (block 230). Thus, for example, where the messages are audio messages, a speaker in the home communication system begins playing the message(s) in serial so that the target can hear the message(s). As another example, where the message(s) are visible messages such as text or video, those messages are displayed to the target.

Where either there are no messages to be provided to the target (block 225) or the available messages have already been provided to the target (block 230), it is determined whether a message send has been selected (block 235). Such a message send may be selected, for example, by determining whether a message send button on the home messaging systems has been pushed. Based upon the disclosure provided herein, one of ordinary skill in the art will recognize a variety of mechanisms that may be used in relation to different embodiments to determine whether a message is to be sent and/or to allow an individual to signal a desire to send a message. Where it is determined that a message send has been selected (block 235), a message is received from the sending individual at the home communication system and forwarded to a remote communication system (block 240).

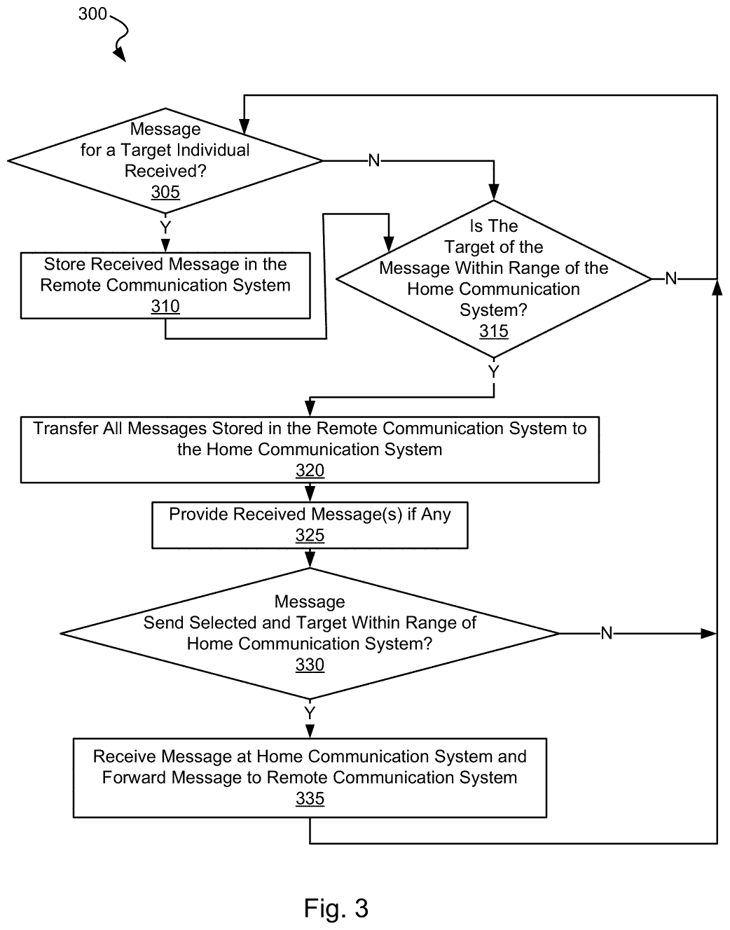

Turning to FIG. 3, a flow diagram 300 shows another method for gating messaging to/from a human subject based upon the location of the human subject in accordance with various embodiments. Following flow diagram 300, it is determined if a message is received for a target individual (block 305). Such a target individual is a human subject recognized by the home communication system, and the message is received from a messaging device. The person operating the messaging device may be, but is not limited to, a parole officer, a boss, or another with an interest in whether a human subject received a message. Based upon the disclosure provided herein, one of ordinary skill in the art will recognize a variety of messaging devices and/or persons or computer programs directing messages to the human subject.

Where a message is received (block 305), the message is stored in a remote communication system until such time that the target of the message is within range of a home communication system assigned to the target (block 310). Where either no additional message was received (block 305) or message storage has been completed (block 310), it is determined whether the target of the message(s) is within a defined distance of the home communication system associated with the target of the messages (block 315). This includes receiving an indication from the home communication device that the target of the message is within range and thus is reasonably assured of receiving any sent message. To make a determination as to whether the target of the message(s) is within a defined distance (e.g., r) of the home communication system, the home communication system determines whether an individual identification device associated with a human subject (i.e., the target of the message(s)) has come within a defined distance of the home communication system. As mentioned above, the individual identification device may be loosely associated with the target of the message(s), or may be a tightly associated individual identification device.

As one example, the individual identification device may be capable of communication with home communication system using an RFID approach where the individual identification device is powered when it enters a radio frequency power field emitted from the home communication system, and upon being powered transmits a radio frequency signal including a message with an identification associated with the target of the message(s). In such cases, the defined distance of the home communication system may be a distance at which RFID communication can be carried out between the individual identification device and the home communication system. As another example, the individual identification device may be capable line of sight communication with the home communication system using, for example, infrared signaling. In such cases, the defined distance of the home communication system may be a distance at which infrared communication can be carried out between the individual identification device and the home communication system. In some cases, the home communication system is deployed in a room of a building effectively limiting the distance at which communication may be carried out. Such near range communication methods assure that the target of the message(s) is within range of the individual identification device, and thus provides reasonable assurance that the target will received the message(s) as the target is within a defined distance (e.g., r) from the home messaging device. Based upon the disclosure provided herein, one of ordinary skill in the art will recognize a variety of near range communication methods that may be employed in relation to different embodiments.

Where the target of the message(s) is not within a defined distance (e.g., a near range) of the home communication system (block 315), any previously stored messages are not transferred to the home communication system. Such messages continue to be stored in the remote communication system.

Alternatively, where the target of the message(s) is within a defined range of the home communication system (block 315), any previously stored messages are transferred to the home communication system (block 320). Such transferring of the message(s) may be done using one or more of a wireless and/or a wired communication path between the home communication system and a remote communication system that received the message.

The received message(s) are then provided to the target which has been determined to be within a defined distance of the home communication system (block 325). Thus, for example, where the messages are audio messages, a speaker in the home communication system begins playing the message(s) in serial so that the target can hear the message(s). As another example, where the message(s) are visible messages such as text or video, those messages are displayed to the target.

Where all available messages have been provided to the target (block 325), it is determined whether a message send has been selected (block 330). Such a message send may be selected, for example, by determining whether a message send button on the home messaging systems has been pushed. Based upon the disclosure provided herein, one of ordinary skill in the art will recognize a variety of mechanisms that may be used in relation to different embodiments to determine whether a message is to be sent and/or to allow an individual to signal a desire to send a message. Where it is determined that a message send has been selected (block 330), a message is received from the sending individual at the home communication system and forwarded to a remote communication system (block 335).

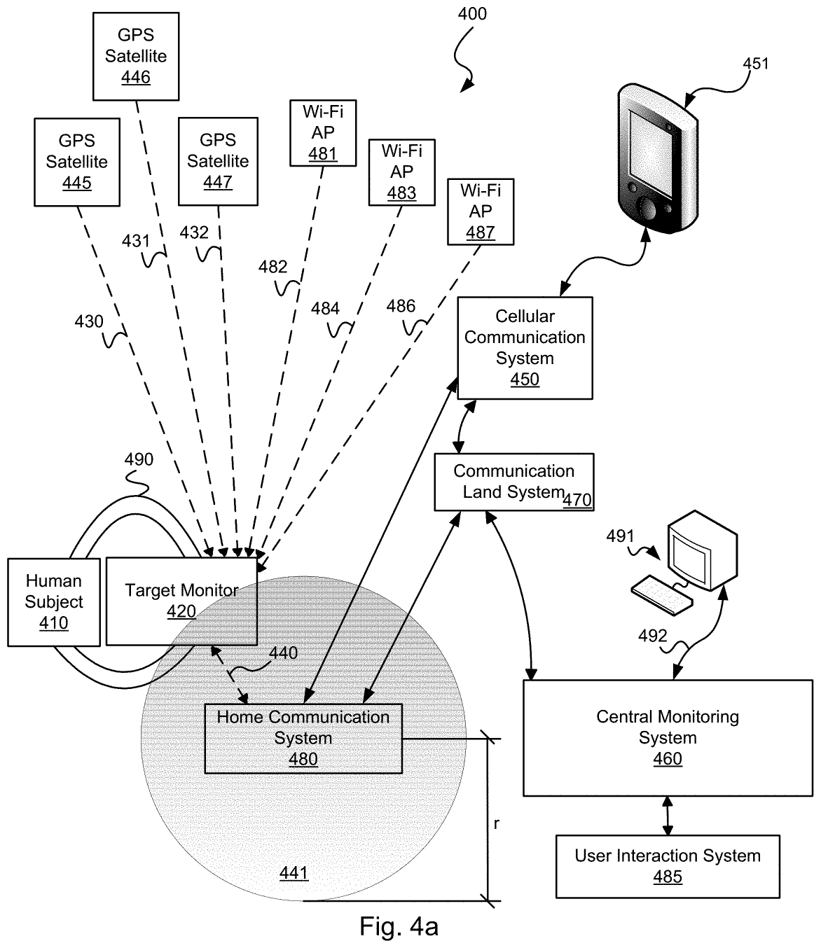

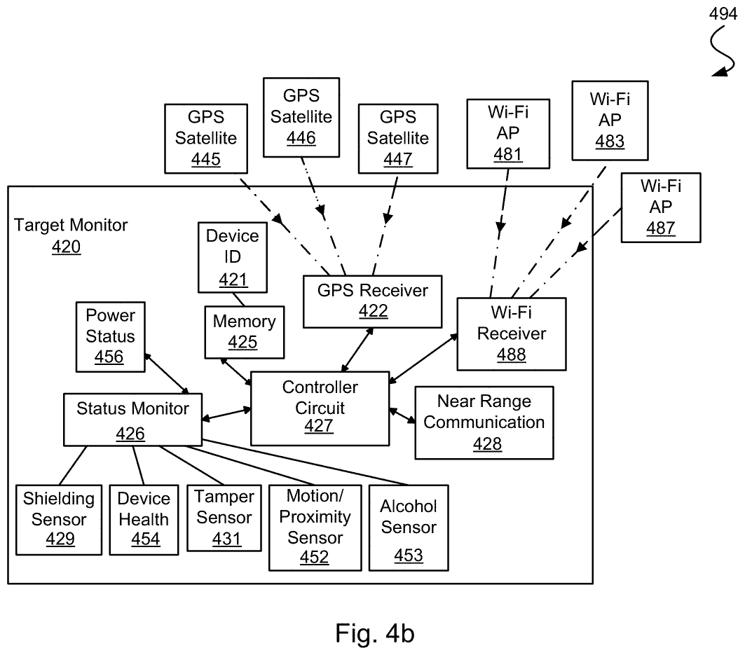

Turning to FIG. 4, a block diagram of a monitoring system 400 is shown that includes a home communication system 480 that has location based message gating capability in accordance with various embodiments. It should be noted that while monitoring system 400 is discussed as using a combination of GPS, Wi-Fi, and AFLT location determination technologies, that other position determination technologies may be used as well. Such other position determination technologies include, but are not limited to, Locaid™ and Get Cell.

Monitoring system 400 includes, but is not limited to, a target monitor device 420 that is physically coupled to a human subject 410 by a securing device 490. In some cases, securing device 490 is a strap that includes a tamper sensor that may be, but is not limited to, a continuity sensor that when broken indicates an error or tamper condition. Further, in some cases, the tamper sensor may be implemented as a proximity sensor that is able to detect when it has been moved away from an individual being monitored. When such movement away from the individual is detected, an error or tamper condition may be indicated. Based on the disclosure provided herein, one of ordinary skill in the art will recognize a variety of tamper sensors that may be incorporated in either target monitor device 420 or securing device 490 to allow for detection of removal of target monitor device 420 or other improper or unexpected meddling with target monitor 420. Further, based upon the disclosure provided herein, one of ordinary skill in the art will recognize a variety of monitors and/or securing devices that may be appropriate where the target of the monitoring is not a human or other animal subject, but rather an asset.

The combination of target monitor device 420 and home communication system 480 support location based gating of messages. Home communication system 480 facilitates near range communication at a maximum distance r between individual identification device 420 and home communication system 405. A shadow area 441 shows an expected region around home communication device 480 where near range communication with target monitor device 420 is possible. Such near range communication is done via a communication path 440. In some cases, such near range communication may be, for example, line of sight communication where communication path 440 represents an infrared communication link between individual identification device 420 and home communication system 480. In such a case, target monitor device 420 may be equipped with infrared communication circuitry and capability, and home communication system 480 is equipped with infrared communication circuitry and capability.

In other cases, such near range communication may be, for example, RFID where communication path 440 represents both a radio frequency power field emitted from home communication system 480 and a radio frequency message from the individual identification device 420 to the home communication system 480. In such a case, target monitor device 420 may be equipped with RFID transponder circuitry and capability, and home communication system 480 is equipped with RFID reader circuitry and capability. Based upon the disclosure provided herein, one of ordinary skill in the art will recognize a variety of near range communication methods that may be employed in relation to different embodiments.

In some cases, target monitor device 420 is further designed to provide the location of human subject 410 under a number of conditions. For example, when target monitor device 420 is capable of receiving wireless GPS location information 430, 431, 432 from a sufficient number of GPS satellites 445, 446, 447 respectively, target monitor device 420 may use the received wireless GPS location information to calculate or otherwise determine the location of human subject 410. As another alternative, when target monitor device 420 is capable of receiving Wi-Fi signals 482, 484, 486 from one or more Wi-Fi access points 481, 483, 487 respectively, target monitor device 420 may use the received Wi-Fi access point identification information along with signal strength information to resolve location. Based on the disclosure provided herein, one of ordinary skill in the art will recognize other types of earth based triangulation that may be used.

In various embodiments, each target monitor device 420 contains a host of their own power status, tampering, shielding, movement, and/or other sensors related to its own device health. While still further embodiments also include a host of other measurement transducers within target monitor device 420 for extracting information, and for later reporting, related to physical properties of human subject 410. For example, measuring for the presence of alcohol and/or other drugs present in human subject 410 may be included in some embodiments of target monitor 120. As one example, the alcohol sensor discussed in U.S. Pat. No. 7,930,927 entitled “Transdermal Portable Alcohol Monitor and Methods for Using Such” and filed by Cooper et al. on Mar. 4, 2008. The entirety of the aforementioned reference is incorporated herein by reference for all purposes.

Monitoring system 400 further includes a control station 491 that is communicably coupled to a central monitoring system 460 via a communication link 492. In one particular embodiment of the present invention, control station 491 is a personal computer including a display device, a processor, and/or one or more I/O devices. Based upon the disclosure provided herein, one of ordinary skill in the art will recognize a variety of systems that may be used as control station 491 including highly tailored application specific control systems.

Central monitoring system 460 includes functionality for sending alerts to a user interaction system 485 when a tracked target ventures into a prohibited zone as updated by the adaptive zone update control, for providing location information indicating a location of target monitor 420, and/or for receiving a request to place target monitor device 420 into one or more supported modes of operation. User interaction system 485 may be, but is not limited to, a law enforcement computer deployed at a dispatch station of the law enforcement facility or a hand held computer maintained by a law enforcement official. Based upon the disclosure provided herein, one of ordinary skill in the art will recognize a variety of user interaction systems 485 that may be used in relation to one or more of the embodiments discussed herein. Further, it should be noted that such a system is not limited to use in relation to law enforcement.

A cellular communication system 450 and/or a communication land system 470 is capable of transferring messages from control station 491 to home communication system 480. Alternatively, cellular communication system 450 is capable of transferring messages from a portable messaging device 451 to home communication system 480. In some cases, messaging device 451 is a cellular telephone or other wireless communication device. Based upon the disclosure provided herein, one of ordinary skill in the art will recognize a variety of messaging devices that may be used in relation to different embodiments. Further, based upon the disclosure provided herein, one of ordinary skill in the art will recognize various communication links and/or remote communication systems that may be used in relation to different embodiments.

Turning to FIG. 4b, a block diagram 494 of target monitor device 420 including various locations support circuitry and near range communication circuitry is shown in accordance with one or more embodiments. As shown, target monitor device 420 includes a device ID 421 that may be maintained in a memory 425, and thus is accessible by a controller circuit 427. Under direction of a circuit controller 427, device ID 421 may be sent to home communication system 480 via a near range communication circuit 428. Where, for example, home communication system 480 relies on RFID communication to determine whether target monitor device 420 is within a defined distance, near range communication circuit 428 is RFID transponder circuitry. Alternatively, where, for example, home communication system 480 relies on infrared communication to determine whether target monitor device 420 is within a defined distance, near range communication circuit 428 is infrared communication circuitry. Based upon the disclosure provided herein, one of ordinary skill in the art will recognize a variety of different circuits that may be used to implement near range communication circuitry 428 depending upon the method(s) employed to determine whether target monitor device 420 is within a defined distance of home communication system 480.

Controller circuit 427 is further able to interact with a GPS receiver 422 and memory 425 at times for storing and generating records of successively determined GPS locations. Similarly, controller circuit 427 is able to interact with a Wi-Fi receiver 488 and memory 425 at times for storing and generating records of successively determined Wi-Fi access point identifications and signal strength. As target monitor device 420 comes within range of one or more Wi-Fi access points (e.g., Wi-Fi access point 481, Wi-Fi access point 483, and Wi-Fi access point 487), Wi-Fi receiver 488 senses the signal provided by the respective Wi-Fi access points, and provides an identification of the respective Wi-Fi access point and a signal strength of the signal received from the Wi-Fi access point to Wi-Fi receiver 488. This information is provided to controller circuit 427 which stores the information to memory 425.

In some cases, when target monitor device 420 is within range of a public Wi-Fi access point, reporting the location of target monitor device 420 may be done via the public Wi-Fi access point to central monitoring system 460. Alternatively, the location data may be uploaded via the home monitoring system 480 using a wired link (not shown) or some time of near range communication.

Various embodiments of target monitor device 420 include a variety of sensors capable of determining the status of target monitor 420, and of the individual associated therewith. For example, a status monitor 426 may include one or more of the following subcomponents: power status sensor 456 capable of indicating a power status of target monitor 420. The power status may be expressed, for example as a percentage of battery life remaining. Based upon the disclosure provided herein, one of ordinary skill in the art will recognize a variety of forms in which power status may be expressed. In addition, target monitor device 420 includes a set of shielding sensors 429 that are capable of determining whether target monitor device 420 is being shielded from receiving GPS signals and/or if GPS jamming is ongoing, a set of device health indicators 454, a tamper sensor 431 capable of determining whether unauthorized access to target monitor device 420 has occurred or whether target monitor device 420 has been removed from an associated human subject, a motion/proximity sensor 452 capable of determining whether target monitor device 420 is moving and/or whether it is within proximity of an individual associated with target monitor 420, and/or an alcohol sensor 453 capable of determining a likelihood that the human subject has engaged in drinking. Based on the disclosure provided herein, one of ordinary skill in the art will recognize a variety of shielding sensors, a variety of device health transducers and indicators, a variety of tamper sensors, various different types of motion sensors, different proximity to human sensors, and various human body physical measurement sensors or transducers that may be incorporated into target monitor device 420 according to various different instances and/or embodiments of the present invention.

In operation, as messages directed to human subject 410 are received from either messaging device 451 or control station 491, the messages are provided to home communication system 480 via one or both of cellular communication system 450 and/or communication land system 470. In turn, home communication system 480 stores the received message(s).

Home communication system 480 continuously queries to determine whether target monitor device 420 is within range of near range communications that are supported. Thus, for example, home monitoring system 480 may emit an RFID energy field and listen for device ID 421 to be returned by target monitor device 420. As another example, home monitoring system 480 may listen for a message transmitted from target monitor device 420 to an infrared receiver (not shown) included in home monitoring system 480, where the transmitted message identifies target monitor device 420.

Once home messaging device 480 determines that target monitor device 420 is within near range communication, home communication system 480 provides any previously stored messages to the human subject associated with target monitor device 420. Thus, for example, where the messages are audio messages, a speaker included in home communication system 480 begins playing the message(s) in serial so that the target can hear the message(s). As another example, where the message(s) are visible messages such as text or video, home communication system 480 provides those message via a visual display included in home communication system 480.

In addition, home communication system 480 determines whether a button on home communication system 480 has been pressed indicating a desire to send a message from home communication system 480 to central monitoring system 460. Where the button is pushed indicating a desire to send a message and target monitor device 420 is within the defined distance, home communication system 480 prompts a user to provide their message and once received the message is forwarded to central monitoring system 460. Based upon the disclosure provided herein, one of ordinary skill in the art will recognize a variety of mechanisms that may be used in relation to different embodiments to determine whether a message is to be sent and/or to allow an individual to signal a desire to send a message.

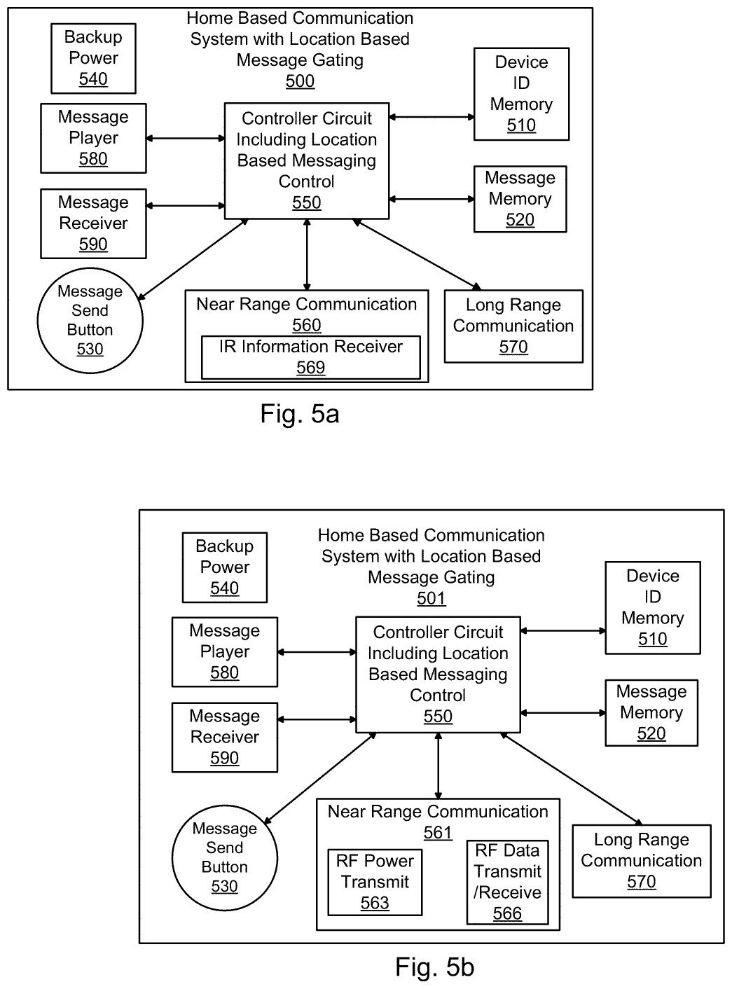

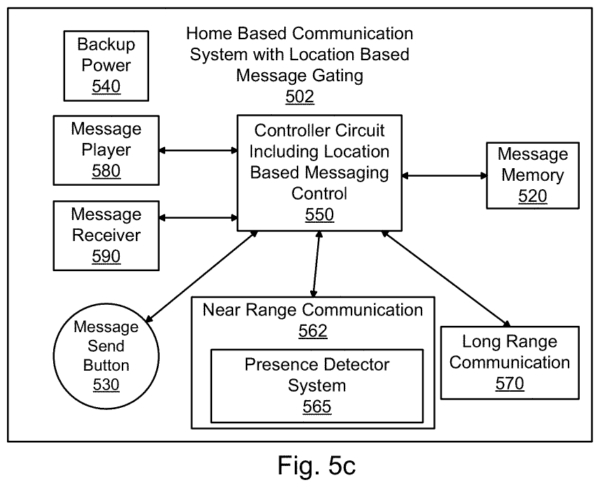

Turning to FIG. 5a, a block diagram illustrates an example home based communication system 500 with location based message gating in accordance with some embodiments. In some cases, home based communication system 500 may be used in place of home communication system 105 of FIG. 1 and/or home communication system 480 of FIG. 4a. Based upon the disclosure provided herein, one of ordinary skill in the art will recognize other systems into which home based communication system 500 may be deployed.

Home based communication system 500 includes a controller circuit 550 including location based messaging control. In some cases, controller circuit 550 includes or is associated with a memory (not shown) that includes instructions executable by controller circuit to implement location based messaging control as described below. In some cases, home based communication system 500 is attached to an external power source (not shown), but additionally includes a backup power source 540 operable to power home based communication system 500 for a finite period upon loss of access to power from the aforementioned eternal power source.

Home based communication system 500 additionally includes a device ID memory 510 that includes one or more set of identification data where the sets of identification data are each associated with respective individuals served by home based communication system 500. In some cases, home based communication system 500 is used in relation to only a single individual. In other cases, home based communication system 500 is used in relation to multiple individuals. Additionally, home based communication system 500 includes a message memory 520. Where home based communication system 500 is used to provide audio messages to individuals, message memory 520 holds audio messages. In other cases where home based communication system 500 is used to provide video messages to individuals, message memory 520 holds video messages. In yet other cases where home based communication system 500 is used to provide text messages to individuals, message memory 520 holds text messages. In various cases, home based communication system 500 provides combination messages (e.g., audio and text message, audio and video messages, video and text messages, or audio, video and text messages) to individuals. In such cases, message memory 520 holds combination messages.

Home based communication system 500 additionally includes a long range communication system 570 that is operable to communicate with, for example, a central monitoring or communication system (not shown) via, for example, a cellular network, or public switched telephone network. Based upon the disclosure provided herein, one of ordinary skill in the art will recognize a variety of long distance communication networks over which information is communicated to/from home based communication system 500. Long range communication system 570 is designed to provide communications via the selected communication network.

Home based communication system 500 further includes a message send button 530, a message receiver 590, and a message player 530. When pressed send button 530 indicates a desire to transmit a message via home based communication system 500 to a designated or default recipient. A default recipient may be, for example, a central monitoring station (not shown) that is monitoring operation of home based communication system 500. A button is just one of many ways of indicating a desire to send a message, and based upon the disclosure provided herein, one of ordinary skill in the art will recognize other interfaces that may be used to indicate a desire to send a message in accordance with other embodiments. Once message send button 530 is pressed, an individual enters their message via message receiver 590. Where the message to be sent is an audio message, message receiver 590 includes a microphone. Alternatively, or in addition, where the message to be sent includes video, message receiver 590 includes a camera. Alternatively, or in addition, where the message to be sent is a text message, message receiver 590 includes a keyboard for entering a text message. Message player 580 is operable to provide a message received by home bases communication system 500. Thus, where the message to be provided is an audio message, message player 580 includes an audio speaker. Alternatively, or in addition, where the message to be provided is a video message or a text message, message player 580 includes a graphical display.

Home based communication system 500 additionally includes a near range communication interface 560 that is operable to determine the presence of an individual within a communication range of the home base communication system, and to provide an indication of individual presence. As shown, near range communication interface 560 includes an infra-red (IR) information receiver 569. IR information receiver 569 is operable to receive a pulsed infra-red signal from an individual identification device (not shown). The pulsed infra-red signal represents an identification of an individual (not shown) associated with the individual identification device.

In operation, a message is received from a sender via long range communication system 570. This message is directed by controller circuit 550 to message memory 520 where it is stored. When a pulsed infra-red signal is received by home based communication system 500, IR information receiver 569 receives the signal and near range communication interface 560 converts the signal to a digital identification provided to controller circuit 550. In turn, controller circuit 550 compares the digital identification to sets of identification data maintained in device ID memory 510 to determine if an individual supported by home based communication system 500 is within range. Where it is determined that an individual supported by home based communication system 500 is within range, controller circuit 550 accesses message memory 520 to determine whether any stored messages are directed to the individual recently identified as within range. Any messages for the individual are accessed from the message memory 520 and played by message player 580.

Where message send button 530 is pressed indicating a desire to send a message and it is determined that an individual supported by home based communication system 500 is within range, controller circuit 550 directs a message received via message receiver 590 to message memory 520 where it is stored until controller circuit 550 directs long range communication system 570 to send the received message to either an indicated recipient or a default recipient for the identified individual.

Turning to FIG. 5b, a block diagram illustrates another example home based communication system 501 with location based message gating in accordance with other embodiments. In some cases, home based communication system 501 may be used in place of home communication system 105 of FIG. 1 and/or home communication system 480 of FIG. 4a. Based upon the disclosure provided herein, one of ordinary skill in the art will recognize other systems into which home based communication system 501 may be deployed.

Home based communication system 501 includes controller circuit 550 including location based messaging control. In some cases, controller circuit 550 includes or is associated with a memory (not shown) that includes instructions executable by controller circuit to implement location based messaging control as described below. In some cases, home based communication system 501 is attached to an external power source (not shown), but additionally includes backup power source 540 operable to power home based communication system 501 for a finite period upon loss of access to power from the aforementioned eternal power source.

Home based communication system 501 additionally includes device ID memory 510 that includes one or more set of identification data where the sets of identification data are each associated with respective individuals served by home based communication system 501. In some cases, home based communication system 501 is used in relation to only a single individual. In other cases, home based communication system 501 is used in relation to multiple individuals. Additionally, home based communication system 501 includes message memory 520. Where home based communication system 501 is used to provide audio messages to individuals, message memory 520 holds audio messages. In other cases where home based communication system 501 is used to provide video messages to individuals, message memory 520 holds video messages. In yet other cases where home based communication system 501 is used to provide text messages to individuals, message memory 520 holds text messages. In various cases, home based communication system 501 provides combination messages (e.g., audio and text message, audio and video messages, video and text messages, or audio, video and text messages) to individuals. In such cases, message memory 520 holds combination messages.

Home based communication system 501 additionally includes long range communication system 570 that is operable to communicate with, for example, a central monitoring or communication system (not shown) via, for example, a cellular network, or public switched telephone network. Based upon the disclosure provided herein, one of ordinary skill in the art will recognize a variety of long distance communication networks over which information is communicated to/from home based communication system 501. Long range communication system 570 is designed to provide communications via the selected communication network.

Home based communication system 501 further includes message send button 530, message receiver 590, and message player 530. When pressed send button 530 indicates a desire to transmit a message via home based communication system 501 to a designated or default recipient. A default recipient may be, for example, a central monitoring station (not shown) that is monitoring operation of home based communication system 501. A button is just one of many ways of indicating a desire to send a message, and based upon the disclosure provided herein, one of ordinary skill in the art will recognize other interfaces that may be used to indicate a desire to send a message in accordance with other embodiments. Once message send button 530 is pressed, an individual enters their message via message receiver 590. Where the message to be sent is an audio message, message receiver 590 includes a microphone. Alternatively, or in addition, where the message to be sent includes video, message receiver 590 includes a camera. Alternatively, or in addition, where the message to be sent is a text message, message receiver 590 includes a keyboard for entering a text message. Message player 580 is operable to provide a message received by home bases communication system 500. Thus, where the message to be provided is an audio message, message player 580 includes an audio speaker. Alternatively, or in addition, where the message to be provided is a video message or a text message, message player 580 includes a graphical display.

Home based communication system 501 additionally includes a near range communication interface 561 that is operable to determine the presence of an individual within a communication range of the home base communication system, and to provide an indication of individual presence. As shown, near range communication interface 561 includes a radio frequency (RF) power transmitter 563 and an RF data transmit/receive interface 566. RF power transmitter 563 provides an RF power field capable of powering a remote identification transponder (not shown). When powered, remote identification transponder transmits an identification identifying the transponder to RF data transmit receive interface 566. The identification identifying the transponder corresponds to an individual associated with the transponder.

In operation, a message is received from a sender via long range communication system 570. This message is directed by controller circuit 550 to message memory 520 where it is stored. When an identification is received by home based communication system 501, RF data transmit receive interface 566 receives the signal and near range communication interface 561 converts the signal to a digital identification provided to controller circuit 550. In turn, controller circuit 550 compares the digital identification to sets of identification data maintained in device ID memory 510 to determine if an individual supported by home based communication system 501 is within range. Where it is determined that an individual supported by home based communication system 501 is within range, controller circuit 550 accesses message memory 520 to determine whether any stored messages are directed to the individual recently identified as within range. Any messages for the individual are accessed from the message memory 520 and played by message player 580.

Where message send button 530 is pressed indicating a desire to send a message and it is determined that an individual supported by home based communication system 501 is within range, controller circuit 550 directs a message received via message receiver 590 to message memory 520 where it is stored until controller circuit 550 directs long range communication system 570 to send the received message to either an indicated recipient or a default recipient for the identified individual.

Turning to FIG. 5c, a block diagram illustrates another example home based communication system 502 with location based message gating in accordance with other embodiments. In some cases, home based communication system 502 may be used in place of home communication system 105 of FIG. 1 and/or home communication system 480 of FIG. 4a. Based upon the disclosure provided herein, one of ordinary skill in the art will recognize other systems into which home based communication system 502 may be deployed.

Home based communication system 502 includes controller circuit 550 including location based messaging control. In some cases, controller circuit 550 includes or is associated with a memory (not shown) that includes instructions executable by controller circuit to implement location based messaging control as described below. In some cases, home based communication system 502 is attached to an external power source (not shown), but additionally includes backup power source 540 operable to power home based communication system 502 for a finite period upon loss of access to power from the aforementioned eternal power source.

Home based communication system 502 includes message memory 520. Where home based communication system 502 is used to provide audio messages to individuals, message memory 520 holds audio messages. In other cases where home based communication system 502 is used to provide video messages to individuals, message memory 520 holds video messages. In yet other cases where home based communication system 502 is used to provide text messages to individuals, message memory 520 holds text messages. In various cases, home based communication system 502 provides combination messages (e.g., audio and text message, audio and video messages, video and text messages, or audio, video and text messages) to individuals. In such cases, message memory 520 holds combination messages.

Home based communication system 502 additionally includes long range communication system 570 that is operable to communicate with, for example, a central monitoring or communication system (not shown) via, for example, a cellular network, or public switched telephone network. Based upon the disclosure provided herein, one of ordinary skill in the art will recognize a variety of long distance communication networks over which information is communicated to/from home based communication system 501. Long range communication system 570 is designed to provide communications via the selected communication network.

Home based communication system 502 further includes message send button 530, message receiver 590, and message player 530. When pressed send button 530 indicates a desire to transmit a message via home based communication system 502 to a designated or default recipient. A default recipient may be, for example, a central monitoring station (not shown) that is monitoring operation of home based communication system 501. A button is just one of many ways of indicating a desire to send a message, and based upon the disclosure provided herein, one of ordinary skill in the art will recognize other interfaces that may be used to indicate a desire to send a message in accordance with other embodiments. Once message send button 530 is pressed, an individual enters their message via message receiver 590. Where the message to be sent is an audio message, message receiver 590 includes a microphone. Alternatively, or in addition, where the message to be sent includes video, message receiver 590 includes a camera. Alternatively, or in addition, where the message to be sent is a text message, message receiver 590 includes a keyboard for entering a text message. Message player 580 is operable to provide a message received by home bases communication system 500. Thus, where the message to be provided is an audio message, message player 580 includes an audio speaker. Alternatively, or in addition, where the message to be provided is a video message or a text message, message player 580 includes a graphical display.

Home based communication system 502 additionally includes a near range communication interface 562 that is operable to determine the presence of an individual within a communication range of the home base communication system, and to provide an indication of individual presence. As shown, near range communication interface 562 includes a presence detector system 565. In one embodiment, presence detector circuit 565 detects motion within a near range of home based communication system 502, and indicates the presence of an individual when motion is detected.

In operation, a message is received from a sender via long range communication system 570. This message is directed by controller circuit 550 to message memory 520 where it is stored. When the presence of an individual is indicated by presence detector circuit 565 and a message is available in message memory 520, controller circuit 550 accesses the message from message memory 520 and provides it to message player 580 where it is played.

Where message send button 530 is pressed indicating a desire to send a message, controller circuit 550 directs a message received via message receiver 590 to message memory 520 where it is stored until controller circuit 550 directs long range communication system 570 to send the received message to either an indicated recipient or a default recipient for the identified individual.

In conclusion, the present invention provides for novel systems, devices, and methods for monitoring individuals and/or assets. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

1. A monitoring system, the monitoring system comprising:
an identification device associated with a human subject, wherein the identification device includes a first near range communication circuit operable to wirelessly transmit an identification;
a communication system located at a predefined location, the communication system including:
a second near range communication circuit operable to receive the identification from the identification device when presented within a defined distance of the communication system;
a memory operable to store at least one message; and
a messaging interface operable to provide the message directly to the human subject based at least in part on communication with the identification device presented within the defined distance of the communication system; and
a central monitoring system configured to receive a physical location data from the identification device via the communication system.

2. The monitoring system of claim 1, wherein the identification device is a tightly associated identification device, and wherein the tightly associated identification device further includes:
a strap operable to physically attach the identification device to the human subject; and
a tamper circuit operable to sense when the identification device has been removed from the human subject.

3. The monitoring system of claim 1, wherein the first near range communication circuit is a radio frequency identification transponder circuit, wherein the second near range communication circuit is a radio frequency reader circuit, and wherein the second near range communication circuit is further operable to transmit information to the first near range communication circuit.

4. The monitoring system of claim 1, wherein the first near range communication circuit is a first infrared communication circuit, and wherein the second near range communication circuit is a second infrared communication circuit.

5. The monitoring system of claim 1, wherein the defined distance is less than one hundred feet.

6. The monitoring system of claim 1, wherein the defined distance is less than twenty feet.

7. The monitoring system of claim 1, wherein the message includes an audio message, and wherein the messaging interface includes an audio speaker.

8. The monitoring system of claim 1, wherein the message is a text message, and wherein the messaging interface includes a visual display.

9. The monitoring system of claim 1, wherein the identification device further includes:
a GPS location determination circuit operable to determine a physical location of the identification device.

10. (canceled)

11. The monitoring system of claim 1, wherein the monitoring system further comprises:
a messaging device operable to send the message to the home communication system.

12. A home base communication system, the system comprising:
a near range communication system operable to determine the presence of an identification device associated with an individual within a communication range of the home base communication system, and to provide an indication of individual presence
within a communication range of the home base communication system, and to provide an indication of individual presence;
a memory operable to store at least one message;
a messaging interface operable to provide the message directly to the individual based at least in part on the indication of individual presence; and
a data transfer circuit configured transfer a physical location data received from the identification device to a central monitoring system.

13. The home base communication system of claim 12, wherein the communication range is less than one hundred feet.

14. The home base communication system of claim 12, wherein the communication range is less than twenty feet.

15. The home base communication system of claim 12, wherein the near range communication system includes an infrared receiver operable to receive an identification associated with a defined individual, wherein the indication of individual presence is provided based upon reception of the identification associated with the defined individual; and wherein the communication range is within line of sight of the home based communication system.

16. The home base communication system of claim 12, wherein the near range communication system is a movement based presence determination system.

17. The home base communication system of claim 12, wherein the near range communication system is a radio frequency identification (RFID) reader, wherein the radio frequency identification (RFID) reader is operable to transmit information to a mobile transponder associated with a defined individual, wherein the radio frequency identification (RFID) reader is operable to receive an identification from the mobile transponder associated with the defined individual, and wherein the indication of individual presence is provided based upon reception of the identification from the mobile transponder associated with the defined individual.

18. The home base communication system of claim 12, wherein the message includes an audio message, wherein the messaging interface includes an audio speaker, and wherein the communication range is an audible range.

19. The home base communication system of claim 12, wherein the message includes a text message, and wherein the messaging interface includes a visual display.

20. The home base communication system of claim 12, wherein the home base communication system further comprises:
a message send interface operable to provide a message send indication; and
a message receive interface operable to receive and send a message only when both the message send indication and the indication of individual presence indicate are both asserted.

21. A method for assuring messages are received by a specified individual, the method comprising:
receiving an audible message for an individual associated with a mobile device at a home base communication system;
storing the audible message to a memory included in the home base communication system;
receiving an individual identification from a mobile device at a home base communication system, wherein reception of the individual identification indicates that an individual associated with the mobile device is within audible range of the home base communication system;
accessing the audible message from the memory included in the home base communication system; and
providing the audible message via an audio speaker in the home base communication system when the individual associated with the mobile device is within audible range of the home base communication system; and
receiving a physical location data from the identification device and transmitting the physical location data to a central monitoring system.

22. The monitoring system of claim 1, wherein the central monitoring system is further operable to receive the at least one message and to transmit the at least one message to the communication system.
